(19) United States
(12) Patent Application Publication
(10) Pub. No.: US 2005/0041778 A1
(43) Pub. Date: Feb. 24, 2005

(54) Micro-diffraction system and method of analyzing sample using the same

(75) Inventors: Jong-sig Lee, Gyeonggi-do (KR); Ki-hong Kim, Gyeonggi-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 10/921,880

(22) Filed: Aug. 20, 2004

(30) Foreign Application Priority Data
Aug. 20, 2003 (KR) 2003-57511

(51) Int. Cl. G01N 23/20

(52) U.S. Cl. 378/79

(57) ABSTRACT

A micro-diffraction system and a method of analyzing a sample using the same are provided. The micro-diffraction system includes an X-ray source, a slit turning an X-ray emitted from the X-ray source into a micro X-ray having a micro-sized spot, a stage on which a sample to be illuminated by the micro X-ray is placed, an observing unit confirming an area of the sample on which the micro X-ray is incident, a detecting unit to detect a diffracted X-ray emitted from the area, a rotating shaft connected to a bottom of the stage and transmitting a rotating force to the stage, a motor assembly which is spaced apart from the rotating shaft and generates the rotating force, a belt transmitting the rotating force produced by the motor assembly to the rotating shaft, a power supply supplying power to the motor assembly and a separating unit separating the stage from one, which does not rotate together with the rotating shaft, of two axes perpendicular to the rotating shaft.

### BACKGROUND OF THE INVENTION

This application claims the benefit of Korean Patent Application No. 2003-57511, filed on Aug. 20, 2003, in the Korean Intellectual Property Office, the disclosure of which is incorporated herein in its entirety by reference.

### 1. FIELD OF THE INVENTION

The present invention relates to a sample analyzing apparatus and a method of analyzing a sample using the same, and more particularly, to a micro-diffraction system which uses an X-ray with a micro-sized spot (hereinafter, referred to as a micro X-ray) for sample analysis, and a method of analyzing a sample using the micro-diffraction system.

### 2. DESCRIPTION OF THE RELATED ART

A diffraction system using a micro X-ray, such as a micro-diffraction goniometer (MDG), is widely used for sample analysis. To analyze a sample using such a micro-diffraction system, first, a micro X-ray is applied to a predetermined portion of the sample. The micro X-ray applied to the sample is diffracted in a direction dependant on the structure of the sample. The X-ray diffracted by the sample is detected by a separate detector to extract necessary data related to the sample.

The fact an X-ray is diffracted by a sample means that there is a crystalline surface that satisfies diffraction conditions in the sample.

Hence, the structure of the sample can be analyzed in consideration of the direction in which the diffracted X-ray is diffracted, the intensity of the detected X-ray, or the like.

FIG. 1 illustrates several components around a sample included in a conventional micro-diffraction system. A sample 12 is mounted on a stage 10.

Referring to FIG. 1, the stage 10 can rotate about a Ψ axis, a Ω axis, and a φ axis, the φ axis passing perpendicularly through the center of the stage 10. A slit 18 separated a predetermined distance from the stage 10 is installed on one side of the stage 10. The slit 18 is composed of first through n-th slits 18a through 18n arranged between an X-ray source (not shown) and the sample 12. Each of the first through n-th slits 18a through 18n has a hole through which an X-ray X generated by the X-ray source can pass. The X-ray generated from the X-ray source has a micro-sized spot which is suitable for analysis of the sample 12 after passing through the first through n-th slits 18a through 18n. The sizes of the first through n-th slits 18a through 18n gradually decrease from the first slit 18a to the n-th slit 18n such that the n-th slit 18n has a micro size. A photon-sensitive detector 20 covering a predetermined solid angle is installed on the opposite side of the slit 18 and detects an X-ray X□ which is diffracted by the sample 12. A microscope 16 is installed over the sample 12 and is disposed at a predetermined angle with the Ω axis. The microscope 16 confirms an area to which the micro X-ray X is to be applied from the entire area of the sample 12.

In the analysis of the structure of the sample 12 using the micro X-ray X, the amount or reliability of data obtained by analyzing the sample 12 may vary depending on which side of the sample 12 the micro X-ray X is incident from, that is, depending on the direction in which the sample 12 is placed with respect to the micro X-ray X.

In the above-described micro-diffraction system, the sample 12 can oscillate about only one of the φ axis, and the φ axis. Accordingly, the direction in which the crystalline surface of the sample 12 faces X-rays is extremely restricted. In other words, this menas that crystal surfaces of the sample 12 capable of searching using micro X-rays are limited in the oscillation about one axis of the axes.

To be more specific, when the sample 12 is oscillated by a given angle about the Ω axis in the conventional micro-diffraction system, crystal faces of the sample 12 that can diffract the emitted micro X-rays are restricted to crystal faces in the plane of the sample 12 and crystal faces that can make an incidence angle conforming to a diffraction condition with the micro X-rays. Other crystal faces cannot be investigated using the micro X-rays X. This fact also applies when the sample 12 is rotated about the Ψ axis or the φ axis.

Thus, conventional micro-diffraction systems cannot study all crystal faces that exist within a sample. Hence, it is difficult to say that data obtained through investigation of a sample using the conventional micro-diffraction systems completely reflects the structure of the sample. Thus, the reliability of the data is not high.

Some micro-diffraction systems other than the conventional micro-diffraction system of FIG. 1 are disclosed in U.S. Pat. Nos. 5,459,770; 5,878,106; and 4,972,448.

### SUMMARY OF THE INVENTION

The present invention provides a micro-diffraction system using micro X-rays, which increases the reliability of analysis data by minimizing the number of crystal faces of a sample that cannot be investigated.

The present invention also provides a method of analyzing a sample using the micro-diffraction system.

According to an aspect of the present invention, there is provided a micro-diffraction system comprising an X-ray source, a slit turning an X-ray emitted from the X-ray source into a micro X-ray having a micro-sized spot, a stage on which a sample to be illuminated by the micro X-ray is placed, an observing unit confirming an area of the sample on which the micro X-ray is incident, a detecting unit to detect a diffracted X-ray emitted from the area, a rotating shaft connected to a bottom of the stage and transmitting a rotating force to the stage, a motor assembly which is spaced apart from the rotating shaft and generates the rotating force, a belt transmitting the rotating force produced by the motor assembly to the rotating shaft, a power supply supplying power to the motor assembly and a separating unit separating the stage from one, which does not rotate together with the rotating shaft, of two axes perpendicular to the rotating shaft.

The motor assembly may comprise a motor, a housing fixing the position of the motor and a U-belt jig transmitting the rotating force of the motor to the belt, and having a groove formed around its upper end to wind the belt around the groove.

A detachable wedge is installed on an upper end of the U-belt jig to manually control vertical motion of the U-belt jig.

According to another aspect of the present invention, there is provided a method of analyzing a sample. The method may comprise steps of loading the sample on the stage, determining an area of the sample on which the micro X-ray is to be incident, determining an angle of incidence of the micro X-ray on the determined area, determining an oscillation angle of the sample about each of the axes, oscillating the sample about one of the two axes perpendicular to the rotating shaft while oscillating the sample by rotating the rotating shaft, irradiating the micro X-ray onto the determined area, and calculating data about a crystal structure of the sample by detecting the X-ray diffracted by the sample.

During the oscillation of the sample, the stage may be separated from to the axis other than the axis that rotates together with the rotating shaft.

When the stage is separated from the axis which does not rotate, a height of the motor assembly may be adjusted.

An oscillation angle about the rotating shaft may set to 0°-360°, an oscillation angle about one of the two axes perpendicular to the rotating shaft to 0°-45°, and an oscillation angle about the remaining axis to −90°-90°.

Accordingly, an X-ray can illuminate the sample while the sample is being simultaneously rotated about two axes, so that crystal faces that cannot be detected when the sample is rotated about a single axis can be detected. Thus, more data and more kinds of data can be obtained when the diffraction system according to an embodiment of the present invention is used than when a conventional diffraction system is used. Also, when the diffraction system according to an embodiment of the present invention is used, more reliable data can be obtained, and more accurate sample analysis can be made than when the conventional diffraction system is used. In particular, even segregation existing within a minute non-crystalline area can be analysed.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating main elements of a conventional micro-diffraction system that are installed around a sample;

FIG. 2 is a perspective view illustrating major elements of a micro-diffraction system according to an embodiment of the present invention that are installed around a stage;

FIG. 3 is a flowchart illustrating a method of analyzing a sample according to an embodiment of the present invention using the micro-diffraction system of FIG. 2;

FIGS. 4 and 5 are graphs showing results of analyses of X-ray diffractions of a first sample using a conventional micro-diffraction system and a micro-diffraction system according to an embodiment of the present invention, respectively; and

FIGS. 6 and 7 are graphs showing results of analyses of X-ray diffractions of a second sample using a conventional micro-diffraction system and a micro-diffraction system according to an embodiment of the present invention, respectively.

### DETAILED DESCRIPTION OF THE INVENTION

The present invention will now be described more fully with reference to the accompanying drawings, in which exemplary embodiments of the invention are shown. In the drawings, the thicknesses of layers and regions are exaggerated for clarity.

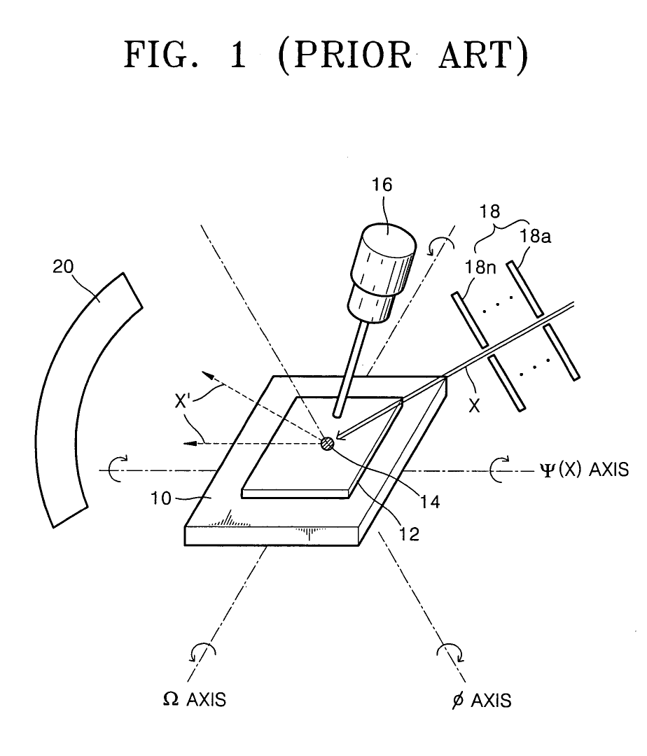

A micro-diffraction system according to an embodiment of the present invention will now be described. Some components included in both the diffraction system according to an embodiment of the present invention and the conventional micro-diffraction system of FIG. 1 are indicated by like reference numerals, and their detailed description will be omitted.

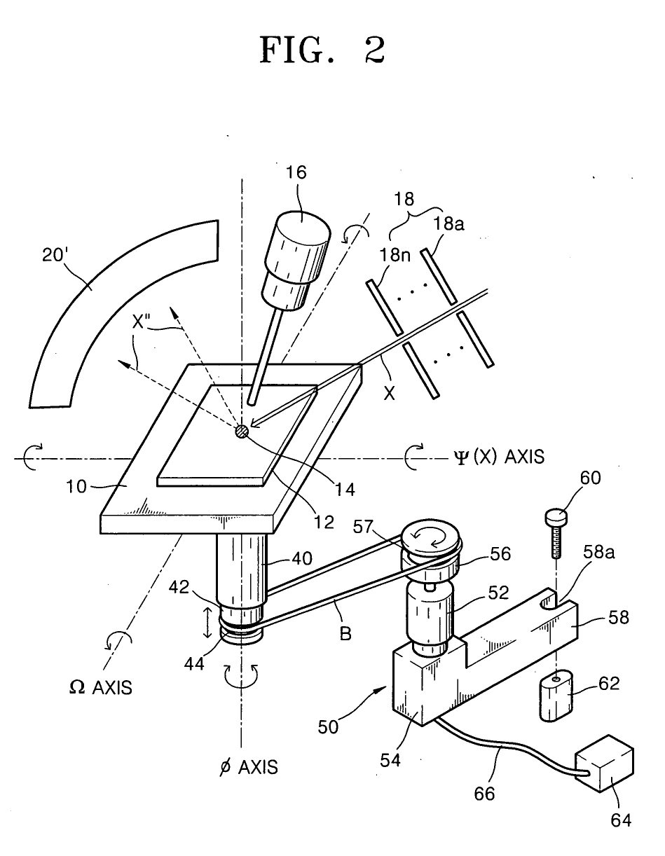

Referring to FIG. 2, a sample 12, which is to be analysed, is put on a stage 10. A micro-slit 18 composed of first through n-th slits 18a through 18n is installed at one side of the stage 10, and a photon-sensitive detector 20′ is installed on the opposite side of the sample 12 to the micro-slit 18. the photon-sensitive detector 20′ must be able to detect all diffracted X-rays X″ produced by a portion 14 of the sample 12, on which an X-ray X is incident, during oscillation of the sample 12. Hence, preferably, the photon-sensitive detector 20 is installed around the portion 14 so as to cover a sufficient solid angle for detecting all of the X-ray X″ diffracted by the sample 12.

Of course, the sample 12 can be oscillated about an axis but can also be simultaneously oscillated about two axes as described later. In the latter case, a radiated X-ray X may be diffracted by a crystalline surface other than the crystalline surface illuminated by the X-ray X in the former case, so the diffraction direction of an X-ray X″ produced in the latter case may be different from that in the former case. Hence, the solid angle of the photon-sensitive detector 20′ in the diffraction system according to an embodiment of the present invention may be different that of the photon-sensitive detector 20 of FIG. 1. A plurality of micro-detectors (not shown) are installed on a surface of the photon-sensitive detector 20′ that faces the sample 12.

A microscope 16 is installed over the sample 12 between the photon-sensitive detector 20′ and the micro-slit 18. The microscope 16 checks the location and area of the portion 14 of the sample 12, on which the X-ray X is incident. For example, the area of the portion 14 on which the X-ray X is incident is several μm² to several mm².

A rotating shaft 40 installed below the stage 10 rotates the stage 10. Preferably, but not necessarily, the rotating shaft 40 and the sample 12 are installed such that they are centered on a φ axis. A first U-belt jig 42 is installed on the bottom end of the rotating shaft 40 and can move a predetermined distance along the φ axis. The vertical motion of the first U-belt jig 42 is made passively. In other words, before or while the structure of the sample 12 is analysed, the position of the first U-belt jig 42 along the φ axis is adjusted. The position of the first U-belt jig 42 along the φ axis can be fixed by inserting a wedge (not shown) into a hole formed around the upper end of the first U-belt jig 42. The first U-belt jig 42 receives a rotating force generated by a motor assembly 50, which is separate from the first U-belt jig 42, and transmits the rotating force to the rotating shaft 40. More specifically, the rotating force generated by the motor assembly 50 is transmitted to the first U-belt jig 42 via a belt B connecting the first U-belt jig 42 to the motor assembly 50. To install the belt B, a first groove 44 is formed around the bottom end of the first U-belt jig 42. The belt B is wound around the first groove 44 and a second groove 57 formed in a second U-belt jig 56. The second U-belt jig 56 forms the upper end of the motor assembly 50.

The motor assembly 50 includes a motor 52, which generates a rotating force, a housing 54, which supports the motor 52, and the second U-belt jig 56, which delivers the rotating force while being rotated by the rotating force received from the motor 52. The motor 52 is, for example, a direct current motor, and is connected to an external power supply 64 via the housing 54 and a cable 66. The housing 54 includes a horizontal portion 58 having a U-shaped groove 58a at one end, into which a bolt 60 for fixing the housing 54 is inserted. When the bolt 60 is inserted into the U-shaped groove 58a, the head of the bolt 60 presses down on the perimeter of the U-shaped groove 58a. Thus, the housing 54 is fixed in place.

As will be described later, the rotating shaft 40 and the first U-belt jig 42 together with the stage 10 may simultaneously move up and down in connection with simultaneous rotations of two axes. In this process, when the horizontal position of the first groove 44 of the first U-belt jig 42 is higher than that of the second groove 57 of the second U-belt jig 56, the motor assembly 50 must be lifted by a movement distance of the first U-belt jig 42 in order to make the second groove 57 of the second U-belt jig 56 level with the first groove 44 of the first U-belt jig 42. To achieve this, a wedge 62 may be included below the U-shaped groove 58a of the housing 54. The wedge 62 has a hole into which the bolt 60 can be inserted. When the wedge 62 is included, the bolt 60 is fixed to the hole of the wedge 62.

The sample 12 may be oscillated about a single axis or simultaneously oscillated about two axes. In the latter case, the sample 12 is oscillated about the φ axis by oscillating the motor 52 of the motor assembly 50 and at the same time, oscillated about the Ψ axis or Ω axis. Hence, in the latter case, the entire area of a hemispherical portion can be scanned, and thus, a preferred orientation crystal face can be analyzed.

To oscillate the sample 12 about two axes, for example, the φ axis and the Ω axis, at the same time, the stage 10 must be separated from the Ψ axis. To do this, a wedge (not shown) is interposed between a rotating shaft (not shown) used to rotate the sample 12 about the Ψ axis and the stage 10. Due to the installation of the wedge, a side of the stage 10 is raised, and the rotating shaft 40, attached to the bottom of the stage 10, and the first U-belt jig 42 are also raised by the same distance by which the stage 10 is raised. Accordingly, it is preferable that the motor assembly 40 is raised by the same amount.

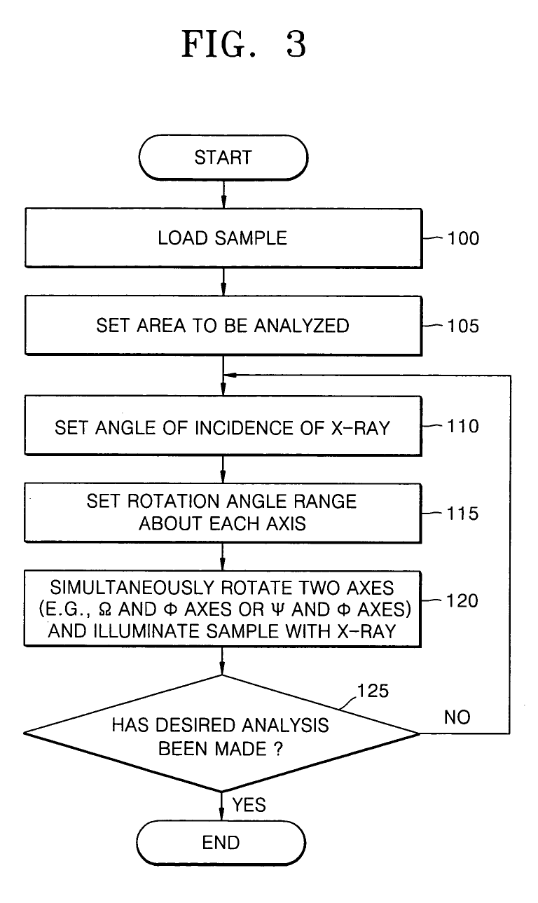

A method of analysing a sample using the diffraction system according to an embodiment of the present invention will now be described with reference to FIGS. 2 and 3. First, in step 100, the sample 12 is loaded to a predetermined location on the stage 10.

In step 105, an area 14, on which a micro X-ray X is incident, is selected from the entire surface of the sample 12. The selected area 14 is confirmed by the microscope 16 and has an area of several μm² to several μm².

In step 110, the angle of incidence of the micro X-ray X on the sample 12 is determined. Also, in step 110, the photon-sensitive detector 20′ is positioned to detect all of the diffracted X-rays X″.

In step 115, the range of rotation of the sample 12 about each of the axes is determined. More specifically, a first rotation angle range of the sample 12 about the Ψ axis, a second rotation angle range of the sample 12 about the φ axis, and a third rotation angle range of the sample 12 about the Ω axis are determined. For example, the first, second, and third rotation angle ranges are −90°-90°, 0°-360°, and 0°-45°, respectively.

After the determination of the first, second, and third rotation angle ranges, a wedge is interposed between an axis which is not rotated simultaneously and the stage 10 to separate the axis and the stage 10. In this case, if the height of the stage 10 is changed, the height of the motor assembly 50 is also adjusted by the change by putting the wedge 62 below the housing 54.

Preferably, but not necessarily, the height adjustment of the motor assembly 50 is performed every time an axis that is not rotated is changed.

Separately from the height adjustment of the motor assembly 50, the height of the second U-belt jig 56 may be adjusted as needed.

In step 120, during simultaneous rotations about two of the axes, micro X-rays X are projected onto the sample 12.

More specifically, when the motor 52 is driven, a rotating force produced by the motor 52 is delivered to the first U-belt jig 42 via the belt B. When the rotating force is felt by the stage 10 via the rotating shaft 40, the sample 12 is rotated over the second rotation angle range, which is determined in step 115. At the same time, the sample 12 is rotated over the first rotation angle range about the Ψ axis or over the third rotation angle range about the Ω axis. As described above, while the sample 12 is being rotated about the two axes, the micro X-ray X is projected onto the selected area 14 of the sample 12.

In step 125, it is determined whether a desired analysis has been made. If the desired analysis has been made, the method is terminated. Otherwise, the method returns to step 110.

An experiment testing the performance of the diffraction system according to an embodiment of the present invention (hereinafter, referred to as a second system) will now be described. In the experiment, the conventional diffraction system of FIG. 1 (hereinafter, referred to as a first system) was used as a comparative example.

The experiment was performed on first and second samples. The first sample was a PZT film specimen, and the second sample was a cathode ray tube glass specimen having crystal defects.

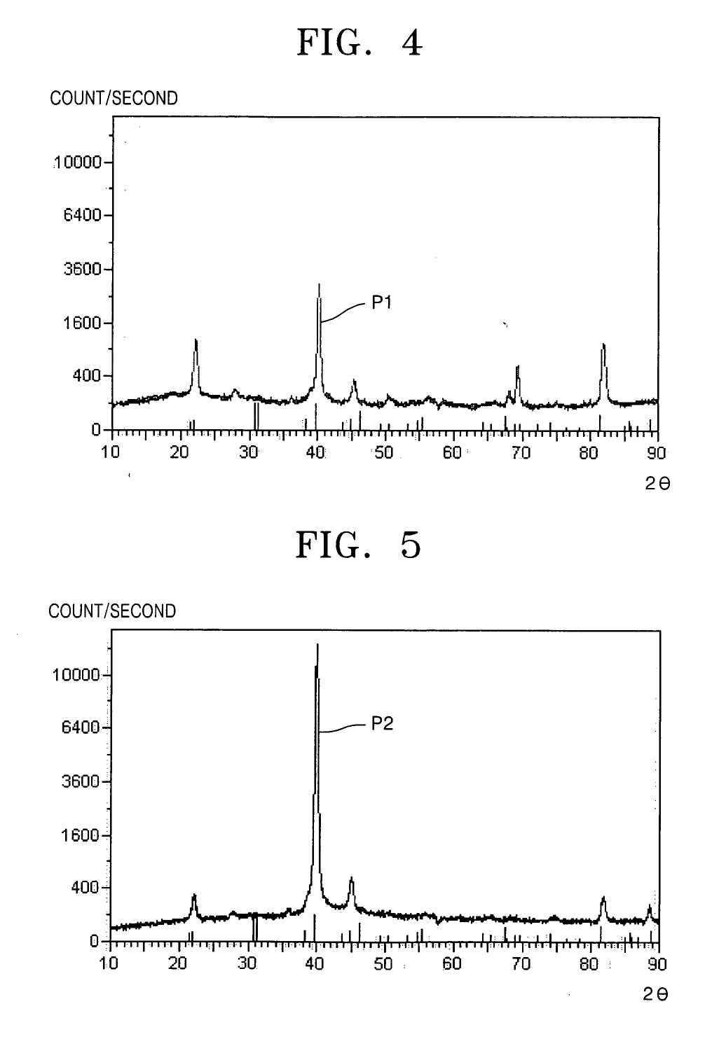

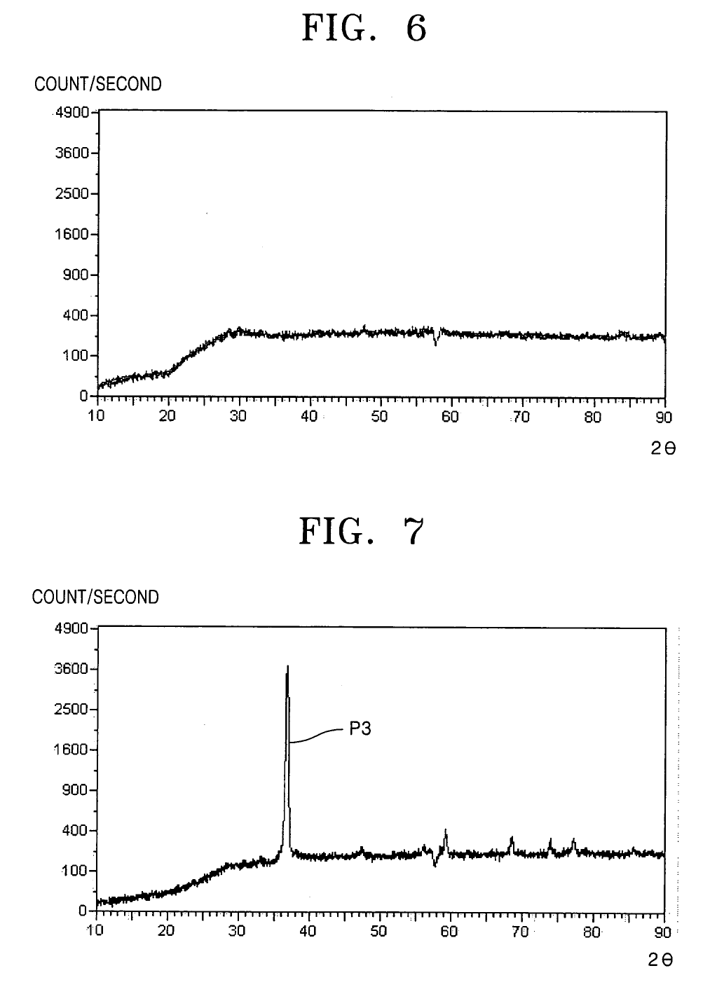

FIGS. 4 and 5 show results of analyses of the first sample using the first and second systems, respectively. FIGS. 6 and 7 show results of analyses of the second sample using the first and second systems, respectively.

When the micro X-ray X was incident upon the first sample at a given angle, a first peak P1 was detected when the first system was used, as shown in FIG. 4. A second peak P2, which is located at the same angle as but much higher than the first peak P1, was detected when the second system was used, as shown in FIG. 5. Thus, the second system could analyze crystal faces within the first sample that could not be investigated by the first system.

When FIGS. 6 and 7 are compared, no peaks are shown in FIG. 6, whereas a third peak P3, which is distinct, is shown in FIG. 7.

These results of the experiment indicate that the first system cannot recognize segregations existing within a local area of a sample, but the second system can. For example, the first system cannot recognize segregation existing within a minute non-crystalline area, but the second system can.

As described above, the diffraction system according to an embodiment of the present invention includes a separate motor assembly capable of rotating a sample about a φ axis. A wedge is used to separate a stage from an axis that does not rotate together with the φ axis. Accordingly, an X-ray can illuminate the sample while the sample is being simultaneously rotated about two axes, so that crystal faces that cannot be detected when the sample is rotated about a single axis can be detected. Thus, more data and more kinds of data can be obtained when the diffraction system according to an embodiment of the present invention is used than when a conventional diffraction system is used. Also, when the diffraction system according to an embodiment of the present invention is used, more reliable data can be obtained, and more accurate sample analysis can be made than when the conventional diffraction system is used. In particular, even segregation existing within a minute non-crystalline area can be analysed.

While the present invention has been particularly shown and described with reference to exemplary embodiments thereof, it will be understood by those of ordinary skill in the art that various changes in form and details may be made therein without departing from the spirit and scope of the present invention as defined by the following claims. For example, means for automatically adjusting the heights of a stage and a motor assembly may be further included in the diffraction system according to an embodiment of the present invention. Also, means for separating a stage from an axis that does not rotate when other two axes rotate can be further included in the diffraction system itself according to an embodiment of the present invention.

1. A micro-diffraction system comprising:
a slit turning an X-ray emitted from an X-ray source into a micro X-ray having a micro-sized spot;
a stage on which a sample to be illuminated by the micro X-ray is placed;
an observing unit confirming an area of the sample on which the micro X-ray is incident;
a detecting unit to detect a diffracted X-ray emitted from the area;
a rotating shaft connected to a bottom of the stage and transmitting a rotating force to the stage;
a motor assembly which is spaced apart from the rotating shaft and generates the rotating force;
a belt transmitting the rotating force produced by the motor assembly to the rotating shaft;
a power supply supplying power to the motor assembly; and
a separating unit separating the stage from one, which does not rotate together with the rotating shaft, of two axes perpendicular to the rotating shaft.

2. The micro-diffraction system of claim 1, wherein the motor assembly comprises:
a motor;
a housing fixing the position of the motor; and
a U-belt jig transmitting the rotating force of the motor to the belt, and having a groove formed around its upper end to wind the belt around the groove.

3. The micro-diffraction system of claim 1, wherein a U-belt jig transmitting the rotating force received from the motor assembly through the belt to the rotating shaft is installed on a bottom of the rotating shaft, and a groove is formed around a bottom end of the U-belt jig to wind the belt around.

4. The micro-diffraction system of claim 3, wherein a detachable wedge is installed on an upper end of the U-belt jig to manually control vertical motion of the U-belt jig.

5. A method of analyzing a sample using the micro-diffraction system of claim 1, the method comprising:
loading the sample on the stage;
determining an area of the sample on which the micro X-ray is to be incident;
determining an angle of incidence of the micro X-ray on the determined area;
determining an oscillation angle of the sample about each of the axes;
oscillating the sample about one of the two axes perpendicular to the rotating shaft while oscillating the sample by rotating the rotating shaft;
irradiating the micro X-ray onto the determined area; and
calculating data about a crystal structure of the sample by detecting the X-ray diffracted by the sample.

6. The method of claim 5, wherein during the oscillation of the sample, the stage is separated from to the axis other than the axis that rotates together with the rotating shaft.

7. The method of claim 6, wherein when the stage is separated from the axis which does not rotate, a height of the motor assembly is adjusted.

8. The method of claim 5, wherein an oscillation angle about the rotating shaft is set to 0°-360°, an oscillation angle about one of the two axes perpendicular to the rotating shaft is set to 0°-45°, and an oscillation angle about the remaining axis is set to −90°-90°.

9. The method of claim 6, wherein a wedge is inserted between the stage and the axis which does not rotate, to separate the stage from the axis which does not rotate when the other two axes rotate.

10. The method of claim 7, wherein a wedge is put below the motor assembly to heighten the motor assembly.

11. The micro-diffraction system of claim 1, further comprising the X-ray source.
